(19) United States
(12) Patent Application Publication
(10) Pub. No.: US 2009/0122686 A1
(43) Pub. Date: May 14, 2009

(54) Method of focus capture in an optical drive

(75) Inventor: Joris Huibert Joseph Geurts, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/815,114

(22) PCT Filed: Jan. 26, 2006
(86) PCT No.: PCT/IB06/50289

§ 371 Date: Jul. 31, 2007

(30) Foreign Application Priority Data
Feb. 4, 2005 (EP) 05100775.5

(51) Int. Cl. G11B 7/135

(52) U.S. Cl. 369/112.23; G9B/7.112

(57) ABSTRACT

The invention relates to a new method for focus capture in an optical drive comprising a collimator lens. Use is made of the pre-programmed collimator lens position to secure a baseline position of the laser spot at a position with respect to an optical record carrier placed in the optical drive such that the correct information layer on the optical record carrier is captured efficiently and accurately.

### FIELD OF THE INVENTION

The present invention relates to optical drives suitable for use in reading and scanning an information layer of an optical record carrier.

### BACKGROUND OF THE INVENTION

Optical drives are well known devices for, among other functions, reading optical record carriers, including optical discs. Different types of drive are available with different wavelengths of light being used and different light path designs being employed. An overview of such devices is given in the Encyclopaedia of Optical Engineering DOI: 10.1081/E-EOE 120009664 published in 2003 by Marcel Dekker, Inc.

In essence, each type of optical drive focuses a beam of light from a source, such as a laser, to a spot, the light spot then being arranged incident on a record carrier. The light in the spot can interact with an information layer on the optical record carrier, as part of a read process for example. Record carriers may have only one information layer, but some have more than one information layer in order to increase the storage capacity of information held on a single optical record carrier.

For a good read process, the spot should also be focussed such that the best focus region is positioned at a level coincident with the information layer to be read. The characteristics and quality of the light spot are important to the optimum functioning of the process. These characteristics are determined in the light path of the optical drive by the optical components placed there. One particularly important optical component, with respect to spot quality, is the collimator lens, which turns a diverging light beam from a laser source into a well-collimated beam. This beam is then incident on an objective lens, placed in the light path to focus the light onto the optical record carrier.

In order to arrange the spot accurately on the optical record carrier so that it is positioned at the correct level with respect to the information layer to be read, calibrations and controls within the optical drive must be employed. When a user has inserted a new optical record carrier into a drive, the drive has to recognize the optical record carrier before further actions (such as reading) can take place. During this optical record carrier recognition phase, many calibrations have to take place in order to get the optimum signal quality. One of the earliest stages is focus capturing. According to the standard method used, on an optical drive comprising a collimator lens, the collimator lens must first be set to the optimal distance for a certain layer. This distance is a pre-determined baseline value related to a specific information layer and is stored in the memory of the optical drive.

A problem with the current method of focus capturing is due to the depth of focus of the spot itself. In the direction of the optical axis of the device, ideally perpendicular to the optical record carrier, the spot has a region of best sharp focus, either side of which lie regions of less sharp focus where the spot is still recognizable and usable but the spot quality is considered to be deteriorated. In the regions of poor spot quality, information is still being returned to the detection system in the drive. This information may be processed such that the servo-subsystem in the drive captures the wrong layer. Subsequent operations of the drive are therefore rendered invalid and have to be repeated for the correct layer, and a layer jump may have to be effected. The time taken to execute the method is thus extended, and the detection process rendered unreliable.

### SUMMARY OF THE INVENTION

It is an object of the invention to provide a method of focus capture in an optical drive comprising a collimator lens, such that the focus capture process is done in a reliable and repeatable way, improving the execution time for the focus capture process and thus the performance of the optical drive.

The object is achieved by the method according to the invention, for initial programming of an optical drive comprising a collimator lens, of a set of positions of the collimator lens, for focus capture on an optical record carrier placed in the optical drive, the optical record carrier comprising a first information layer and a second information layer separated by a distance, comprising steps of:

Determining a first position of the collimator lens such that a read spot of the optical drive is arranged such that a best focus position of the read spot is not coincident with the first information layer and such that a usable depth of focus of the read spot covers only the first information layer;

Determining a second position of the collimator lens such that the read spot of the optical drive is arranged such that the best focus position of the read spot is not coincident with the second information layer and such that the usable depth of focus of the read spot covers only the second information layer;

Incorporating the first position and the second position corresponding to the first information layer and second information layer respectively, into a non-volatile memory of the optical drive, as a set of determined positions of the collimator lens.

In this method the collimator lens positions are adjusted such that the lens arrangement positions the poor quality region of the spot coincident with the information layer to be read (rather than the best focus position as would be the case in the prior art) and such that no other information layers on the optical record carrier overlap the spot through the overall depth of focus of the spot. Here the poor quality region of the spot is taken to mean the region away from the best focus position of the spot where, when this region is used to provide information back to the system, the data contains more bit errors and more noise than is acceptable for correct operation of the system.

The method refers to an optical record carrier with two information layers, but such a method could be extended to an optical record carrier with more than two information layers, with a potential increase in the number of collimator lens positions stored in memory, such that the number of collimator lens positions is equal to or less than the number of information layers.

The initial programming of the drive is done during production. These baseline positions of the collimator lens can be stored in non-volatile memory. During the lifetime of the drive, system calibrations may take place, which may marginally alter these baseline positions, but the effect of this will be to ensure continued good system performance.

In a further embodiment of the invention a method is provided for operation of an optical drive comprising a collimator lens and a set of determined positions of the collimator lens, for focus capture on an optical record carrier placed in the optical drive, the optical record carrier comprising at least two information layers, comprising the steps of:

Starting of a focus acquisition in the optical drive;

Choosing of an information layer;

Moving the collimator lens to a determined position not coincident with the chosen information layer;

Catching focus at the determined position for the chosen information layer;

Further moving of the collimator lens, to a further position, so that optimum spot quality is obtained for the chosen information layer.

When the optical drive is in operation, it is customary to use the focus acquisition process to position the best focus position of the read spot at the focus position of the optical record carrier information layer to be read. This can allow the usable depth of focus of the read spot to overlap more than one information layer. The focus catch then performed can lock on to the wrong layer. Once the drive operation starts, the incorrect layer choice is identified and then must be corrected. In the method of operation according to the invention, such an incorrect layer choice is averted by ensuring the usable depth of focus of the read spot does not cover any information layer except for the one chosen.

### BRIEF DESCRIPTION OF THE DRAWINGS

The method according to the invention will be further elucidated with reference to the following figures:

FIG. 1 shows an example of an optical light path comprising a collimator lens in an optical drive.

FIG. 2 illustrates a focus capture method according to prior art

FIG. 3 illustrates a focus capture method according to the invention

FIG. 4 is a flowchart of the method according to the invention for initial programming of an optical drive.

FIG. 5 is a flowchart of the method according to the invention for operation of an optical drive.

It should be noted that in the figures the optical record carrier 6 is shown as having two information layers (layer 0 and layer 1) as an example, but the method of the invention could be applied to a optical record carrier having a plurality of information layers.

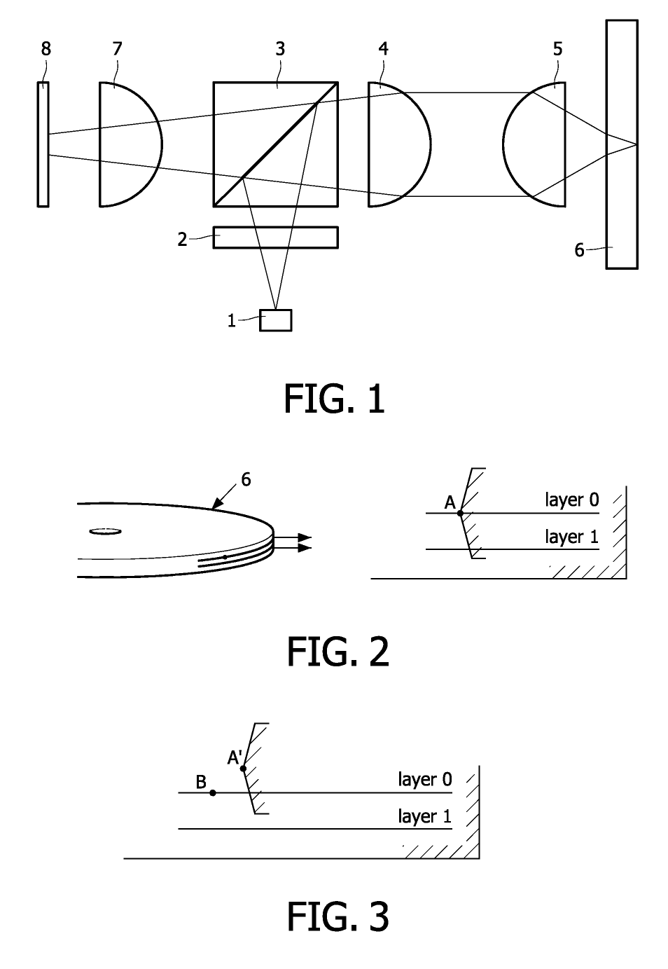

FIG. 1 shows a schematic diagram of an optical drive, with key elements labelled 1 to 8. These elements combine to function such that light from the laser 1 passes through the device optics to the optical record carrier 6 and is then returned from the optical record carrier 6 to the detector 8. A grating 2 serves to produce auxiliary beams for other drive functions, which will not be further described here. A beam splitter 3 is added to the device to direct the beam reflected from the optical record carrier 6 to the detector 8. The laser diode 1 emits a diverging beam, thus requiring the light path to include the collimator lens 4, which turns the diverging beam into a well collimated one. The beam thus formed is then incident on the objective lens 5 and is focussed onto the optical record carrier 6. Light is reflected from the optical record carrier 6 and travels back to the beam splitter 3 where it is directed into the servo branch of the device towards the servo lens 7. The servo lens 7 directs and focuses the light onto the detector 8. A system such as that just described comprises elements of an optical drive known in the current state of the art.

For the purposes of the invention, it should be noted that the collimator lens 4 is the lens utilized to produce the spot positioning which is a feature of the invention.

FIG. 2 details the position of the information contained in layer 0 and layer 1 with respect to the optical record carrier 6. Information layers layer 0 and layer 1 are in the plane of the optical record carrier 6 and are positioned one above the other. Position A and associated region indicated by hatching show the baseline spot position and spot depth of focus respectively, produced in the current state of the art focus capture method whereby the best spot focus is coincident with the information layer to be read, in this case layer 0. It can be seen that the depth of focus of the spot overlaps with the other information layer 1. Thus data from this layer is fed back into the optical device and is detected. Such a depth of focus might be so large that the servo subsystem would catch on layer 1. The device can recognize on which layer it is focussed by means of reading addresses from the optical record carrier. Once it is established that the device is at the wrong layer, corrective action must be taken. Subsequent calibrations on this layer at the wrong position would be inaccurate and worthless as the collimator lens 4 is at the wrong position for this layer. Thus before calibrations take place the servo system (not shown) must perform a jump to the other layer. All these operations are costly with respect to time and efficiency of the drive.

By contrast, FIG. 3 shows the focus capture method according to the invention. Before the focus catch is started, the collimator lens 4 is not set for an optimal spot quality on a certain layer, but is set such that the depth of field is sufficient to get acceptable spot quality on the requested layer, layer 0. This focus position for best spot quality is labelled A′ in the figure. When the focus acquisition starts, the focus catch will be at the requested layer. The next action is to move the collimator 4 so that the best position of the focus spot is at point B. Calibrations can then take place in the security of having located the correct information layer, followed by the rest of the optical record carrier 6 recognition process, and eventually the required device operation, such as a read process.

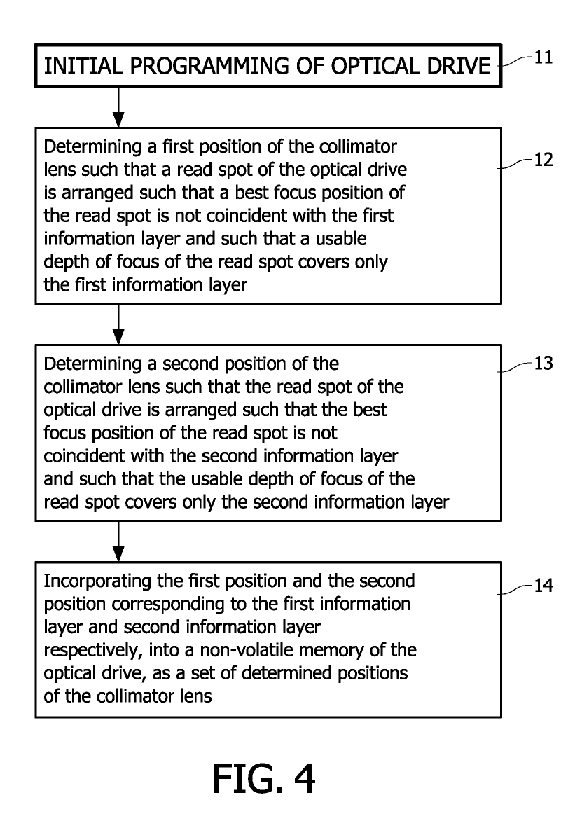

FIG. 4 details a flowchart of the method according to the invention for initial programming of an optical drive, as described above.

In the initial programming of the optical drive 11, the collimator lens 4 is arranged so that the spot has a quality, which, while not being optimal on the chosen information layer of the optical record carrier 6, is still good enough to provide information back to the system from this layer. The usable depth of focus of the read spot is coincident with the chosen information layer but the best focus position of the read spot is not. The other layers present on the optical record carrier 6 are simultaneously in the region of poor spot quality and thus no information on these layers is returned to the system. This baseline collimator lens position so determined 12 is unique for a particular information layer. Another information layer present on the optical record carrier 6 will have an associated baseline position and this position must also be determined 13. The complete set of baseline positions can then be stored 14 in the memory of the optical drive so that they can be accessed once the drive is set into operation. While two information layers have been described, it is possible to extend the method to more than two information layers, with corresponding increase in the number of determined positions of the collimator lens stored in memory.

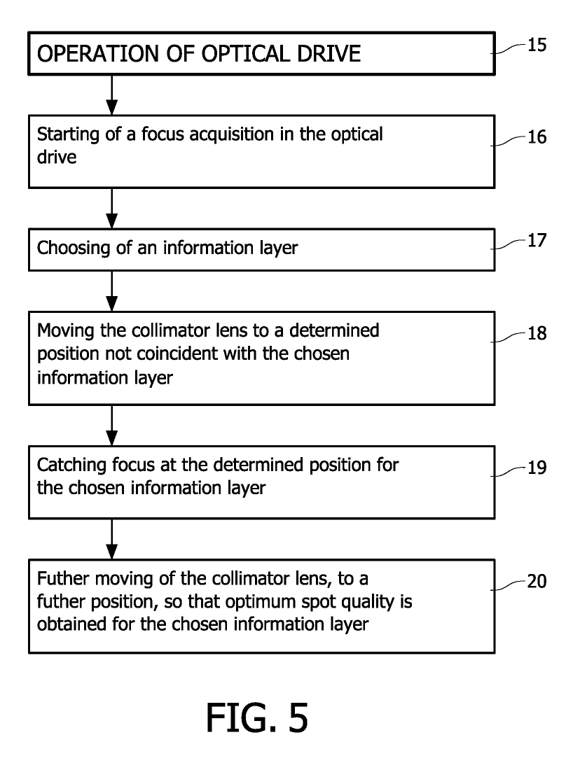

FIG. 5 is a flowchart of the method according to the invention for operation of an optical drive. The operation sequence in the method 15 starts with an initiation of the focus acquisition process 16. An information layer is selected 17. The collimator lens 4 is moved to the baseline position, as previously determined and stored in system memory, for the chosen optical record carrier information layer 18. This careful positioning allows focus catch at the layer 19, which is immediate and not subject to errors of acquiring the wrong information layer as, due to the method, no other information layer can be detected at this stage. Once the focus catch is achieved, the optimum spot quality can be arranged to coincide with the information layer 20. Once this is done, the system can continue to perform other required calibrations, which may be necessary for the operation mode requested by the user of the system, on the correct information layer. This sequence (17 to 20) can be repeated for the layers to which access is needed.

### LIST OF REFERENCE NUMERALS

1. Laser diode

### 2. Grating

3. Beam splitter
4. Collimator lens
5. Objective lens
6. Optical record carrier
7. Servo lens
8. Detector means
layer 0: first information layer on optical record carrier
layer 1: second information layer on optical record carrier
A: baseline focus spot position according to prior art
A′: baseline focus spot position according to the invention
B : final focus spot position according to the invention
11 to 20: process steps in the method according to the invention

1. A method (11) for initial programming of an optical drive comprising a collimator lens, of a set of positions of the collimator lens (4), for focus capture on an optical record carrier (6) placed in the optical drive, the optical record carrier (6) comprising a first information layer (layer 0) and a second information layer (layer 1) separated by a distance, comprising steps of:
Determining (12) a first position of the collimator lens (4) such that a read spot of the optical drive is arranged such that a best focus position of the read spot (A′) is not coincident with the first information layer (layer 0) and such that a usable depth of focus of the read spot covers only the first information layer;
Determining (13) a second position of the collimator lens (4) such that the read spot of the optical drive is arranged such that the best focus position of the read spot (A′) is not coincident with the second information layer (layer 1) and such that the usable depth of focus of the read spot covers only the second information layer (layer 1);
Incorporating (14) the first position and the second position corresponding to the first information layer and second information layer respectively, into a non-volatile memory of the optical drive, as a set of determined positions of the collimator lens (4).

2. A method (15) for operation of an optical drive comprising a collimator lens (4) and a set of determined positions of the collimator lens, for focus capture on an optical record carrier (6) placed in the optical drive, the optical record carrier (6) comprising at least two information layers (layer 0 and layer 1), comprising the steps of:
Starting of a focus acquisition in the optical drive (16);
Choosing of an information layer (17);
Moving the collimator lens to a determined position not coincident with the chosen information layer (18);
Catching focus at the determined position for the chosen information layer (19);
Further moving of the collimator lens, to a further position, so that optimum spot quality is obtained for the chosen information layer (20).
